(19) United States
(12) Patent Application Publication
(10) Pub. No.: US 2016/0357787 A1
(43) Pub. Date: Dec. 8, 2016

(54) METADATA EXTRACTOR FOR SOFTWARE APPLICATIONS

(71) Applicant: SAP SE, Walldorf (DE)

(72) Inventors: Roland Kolata, Walldorf (DE); Sandra Bracholdt, Riesa (DE); Volker Saggau, Bensheim (DE)

(21) Appl. No.: 14/732,155

(22) Filed: Jun. 5, 2015

(51) Int. Cl. G06F 17/30; G06F 3/0484

(52) U.S. Cl. CPC G06F 17/30292; G06F 3/04842

(57) ABSTRACT

According to an embodiment of the present disclosures, systems, methods, and non-transitory computer-readable mediums having program instructions thereon, provide for a framework for automatically transferring metadata from different sources and different components of a computing platform. Further, the framework also provides for the seamless inclusion of additional metadata sources from the computing platform. The framework also provides for visualizing (e.g., modeling) the extracted metadata with a graphical user interface software application.

### FIELD

The present disclosure relates generally to a framework for automatically transferring metadata from different sources and different components of a computing platform.

### BRIEF DESCRIPTION OF THE DRAWINGS

The accompanying drawings illustrate the various embodiments and, together with the description, further serve to explain the principles of the embodiments and to enable one skilled in the pertinent art to make and use the embodiments.

FIG. 1 illustrates an embodiment of a metadata structure supported by the framework of the present invention.

FIG. 2A illustrates an embodiment of the interaction of a software application and computing platform via the framework of the present invention.

FIG. 2B depicts an embodiment of a registration table utilized to incorporate extractors for the framework.

FIG. 2C illustrates an embodiment of source code utilized to implement a function module at the computing platform.

FIG. 3 illustrates an embodiment of a method utilizing the framework of the present invention.

FIG. 4 illustrates an embodiment of a system utilizing the framework of the present invention.

FIG. 5 illustrates an embodiment of the interaction between the elements of the system.

### DETAILED DESCRIPTION

According to an embodiment of the present disclosures, systems, methods, and non-transitory computer-readable mediums having program instructions thereon, provide for a framework for automatically transferring metadata from different sources and different components of a computing platform. Metadata is used to describe the properties of other data. For example, metadata could describe the data type (e.g., string) of other data and if there are any restrictions (e.g., language independent or language dependent) on the other data. Further, metadata could also include the relations from elements of one data object to elements of another data object. Further, the data model descriptions of metadata can differ depending on the software application and/or storage location corresponding to the metadata. For example, for the SAP NetWeaver® platform, the data model descriptions for metadata corresponding to the Data Dictionary (DDIC) are different than the data model descriptions corresponding to the Business Warehouse (BW) DataSource repository. However, the data models descriptions for the DDIC and the BW DataSource repository do follow a similar basic structure. Further, the aforementioned data model descriptions for the DDIC and the BW DataSource repository could be visually modeled with certain software applications (e.g., SAP Power Designer® EnterpriseArchitect), thereby allowing the metadata to be graphically depicted with all its various components (e.g., packages, sub-packages, objects, fields, relations between objects, etc.). However, current solutions require that developers manually build the metadata data models in the software application. Specifically, the metadata data models are built in the software application based on tabular descriptions of the data model descriptions (e.g., for the DDIC and/or the BW DataSource repository) provided by the developer. In other words, current solutions do not provide a method of automatically extracting and utilizing (e.g., modeling) metadata corresponding to different data models from different storage locations (e.g., DDIC, BW DataSource, etc.) at the computing platform (e.g., SAP NetWeaver® platform).

In an embodiment, the present invention is directed to a framework which provides the same extraction and visualization (e.g., modeling) capabilities for different sources of metadata (e.g., DDIC, BW DataSource, etc.). Further, in an embodiment, the framework of the present invention also provides for the seamless inclusion of additional metadata sources. Accordingly, with the present invention, a single framework can be utilized to automatically extract and transform (e.g., model) metadata from as many sources of metadata as required by a developer. In an embodiment, for any metadata source that the developer would like transformed with the software application, the developer would first have to register the metadata source with the framework. In an embodiment, the framework includes, in a registration table, a list of extractors corresponding to the metadata source as well as their corresponding API function modules. In an embodiment, the API function modules refer to extracting functions which extract certain aspects of the metadata (e.g., (1) packages, (2) sub-packages, (3) objects of the packages and/or sub-packages (4) fields of the objects and (5) relations between the objects) to eventually be utilized by the software application. In an embodiment, because metadata data models corresponding to the same computing platform (e.g., SAP NetWeaver® platform) have a similar basic structure (e.g., a hierarchical data structure comprised of (1) packages and/or sub-packages (2) objects of the packages and/or sub-packages (3) fields of the objects, and (4) relations between the objects), the developer can build API function modules for each additional metadata source corresponding to the basic structure of the various metadata data models in the computing platform. Further, in an embodiment, the software application would have to merely connect to the framework in order to make use of any of the extractors and their corresponding API function modules. Accordingly, with the framework of the present invention, the software application is able to seamlessly extract and utilize metadata from any storage location in the computing platform.

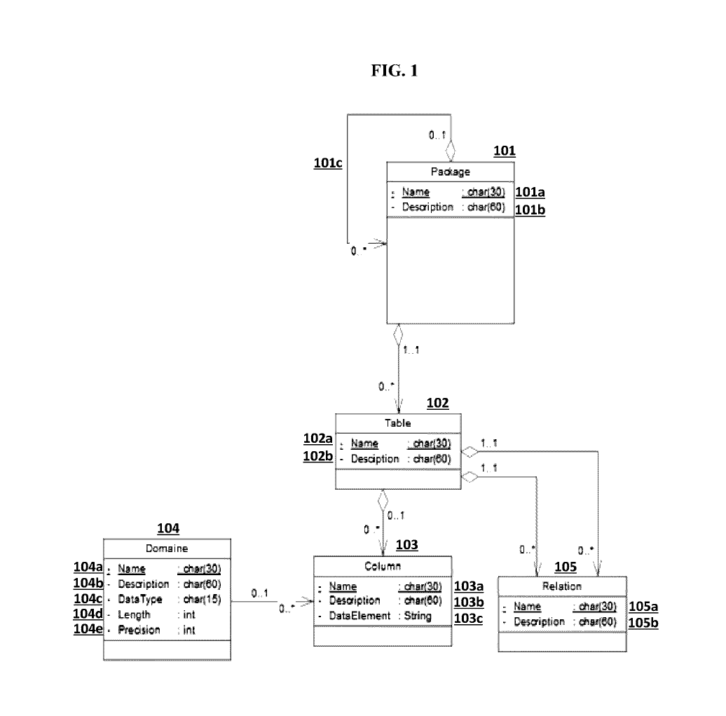

FIG. 1 illustrates an embodiment of a metadata structure supported by the framework. In an embodiment, the framework of the present invention supports metadata with a hierarchical structure. In an embodiment, FIG. 1 depicts the internal structure of metadata stored at the DDIC (e.g., a metadata repository for the SAP NetWeaver® platform). However, in an embodiment, the internal structure of metadata stored at other locations of the computing platform (e.g., SAP NetWeaver® platform) would follow a similar structure. In an embodiment, the metadata of the present invention is organized in structuring elements, e.g., packages 101. In an embodiment, each package 101 corresponds to a name 101a and a description 101b. In an embodiment, name 101a is language-independent and description 101b (as well as all other descriptions) is language-dependent. In another embodiment, packages 101 can include nested sub-packages, which is depicted by arrow 101c. In an embodiment, each package 101 (or sub-package) includes objects 102. In an embodiment, object 102 can be a table (see FIG. 1). In an embodiment, each object 102 corresponds to a name 102a and a description 102b. In an embodiment, each object 102 consists of fields 103. In an embodiment, field 103 can be a column of a table (see FIG. 1). In an embodiment, similar to package 101 and object 102, field 103 can also correspond to a name 103a and a description 103b. Further, in another embodiment, fields 103 can also correspond to a data element 103c (e.g., a description of the technical type of information the field 103 can store) and domains 104. In an embodiment, a domain is a master data type. Accordingly, all fields that have a certain domain (e.g., “myCharacter”) are restricted to this data type. Thus, consistency in the model is ensured. In an embodiment, in addition to name 104a, description 104b, and data type 104c, domain 104 can also correspond to a length entry 104d (e.g., in order to limit the number of characters that can be stored in a field) and precision entry 104e (e.g., in order to limit the preciseness of a measure of “key figure”-like information). In an embodiment, each object 102 can relate to other objects with relations 105. In an embodiment, relations 105 can correspond to a name 105a and a description 105b. In an embodiment, the objects 102 can be related to each other through the use of a key-based relationship. In an embodiment, the software application utilizes (e.g., models) the metadata based on the hierarchical structure depicted in FIG. 1. In other words, the utilized metadata structure will consist of a package, below which includes connected sub-package(s) or object(s). In an embodiment, if the package includes sub-packages, the object(s) of the sub-package(s) will be included below the sub-package(s). Further, the object(s) of either the package or the sub-package(s) will include field(s) beneath them. Further, relations between the various objects of either the package or the sub-package(s) will be depicted with a connection distinguishable from the connection depicting a hierarchical relationship (e.g., package-->sub-package-->object-->field). For example, the relation between the objects can be depicted with a first color and the hierarchical relationship between the package, sub-package, object and fields can be depicted with a second color.

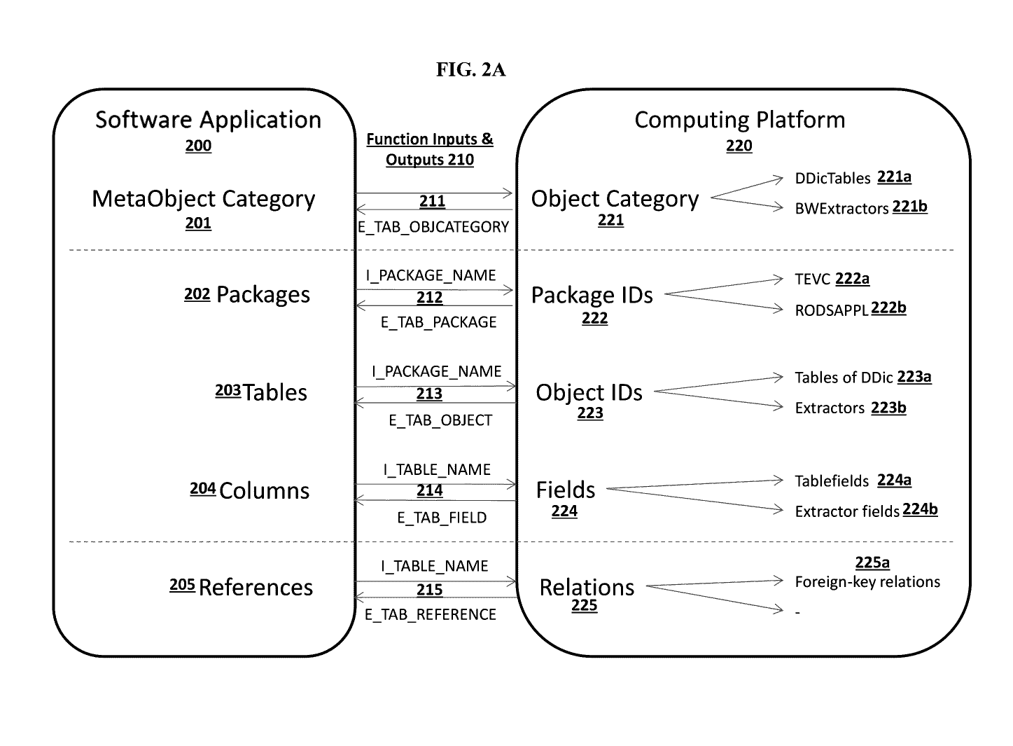

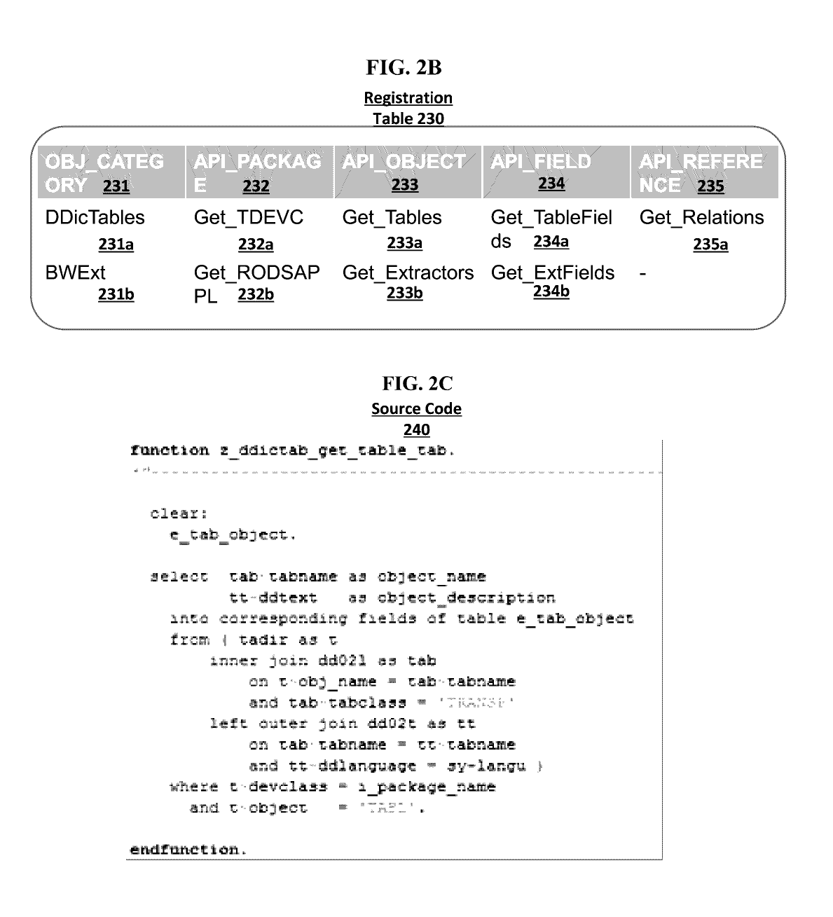

FIG. 2A illustrates an embodiment of the interaction of a software application and computing platform via the framework of the present invention. Software application 200 interacts with computing platform 220 in order to extract and automatically utilize metadata from the computing platform 220. In an embodiment, as depicted in FIG. 2A, each metadata model component in the software application 200 has a corresponding metadata component in the computing platform 220. For example, (i) MetaObject Category 201 corresponds to Object Category 221, (ii) Packages 202 corresponds to Package IDs 222, (iii) Tables 203 corresponds to Object IDs 223, (iv) Columns 204 corresponds to Fields 224 and (v) References 205 corresponds to Relations 225. Therefore, in an embodiment, selecting a metadata component in software application 200 (e.g., 202-205) causes the corresponding metadata component in computing platform 220 to perform an extracting function on metadata at one of the metadata storage locations (e.g., DDIC or the BW DataSource repository). In an embodiment, software application 200 interacts with computing platform 220 via function inputs and outputs 210. For example, as depicted in FIG. 2A, the software application 200 has the option between the extractor for the DDIC (e.g., DDicTables 221a) and the extractor for the BW DataSource (e.g., BWExtractors 221b). If the developer selects to utilize extractor DDicTables 221a, for example, then computing platform 220 will provide the software application 200 with use of the extractor DDicTables 221a and, accordingly, its corresponding function modules TEVC 222a (e.g., in order to extract metadata related to any sub-packages), Tables of DDic 223a (e.g., in order to extract metadata related to the objects of the given package or sub-package), Tablefields 224a (e.g., in order to extract metadata related to the fields of the given object) and Foreign-key relations 225a (e.g., in order to extract metadata related to any relations between the objects of the given package). On the other hand, if the developer selected to utilize extractor BWExtractors 221b, then computing platform 220 will provide the software application 200 with use of the extractor BWExtractors 221b and, accordingly, its corresponding function modules RODSAPPL 222b (e.g., in order to extract metadata related to any sub-packages), Extractors 223b (e.g., in order to extract metadata related to the objects of the given package or sub-package) and Extractor fields 224b (e.g., in order to extract metadata related to the fields of the given object). In other words, because the structure of the metadata in the DDIC and the BW DataSource repository follow a similar structure, the framework of the present invention can seamlessly extract metadata from either of the storage locations. Accordingly, any metadata storage location can be included in the framework as long the structure of the metadata in the additional storage location follows a similar structure as the other storage locations corresponding to the same computing platform (e.g., SAP NetWeaver® platform).

In an embodiment, each of the function modules (e.g., 222a-225a or 222b-224b) related to the respective extractor (e.g., DDicTables 221a or BWExtractors 221b) requires a specific input and produces a specific output. For example, if the developer chooses to extract metadata related to any sub-packages a given package may have by selecting Packages 202, the name of the given package has to be input to either of the function modules related to Package IDs 222 (e.g., 222a or 222b). Then, the function module (e.g., either 222a or 222b) would output a table of the sub-package names and descriptions corresponding to the inputted package. Similarly, in order to extract metadata related to the objects of the given package (or sub-package) by selecting Tables 203 in the software application 200, the name of the given package has to be input to either of the function modules related to Object IDs 223 (e.g., 223a or 223b). Then, the function module (e.g., either 223a or 223b) would output a table of object (or table) names and descriptions corresponding to the inputted package. Further, in order to extract metadata related to fields of the given object by selecting Columns 204 in the software application 200, the name of the given object has to be input to either of the function modules related to Fields 224 (e.g., 224a or 224b). Then, the function module (e.g., either 224a or 224b) would output a table of field (or column) names, descriptions, data types, etc. corresponding to the inputted object. Further, in order to extract metadata related to any relations between the objects of the given package by selecting Reference 205, the name of the given package has to be input to the function module related to Relations 225 (e.g., 225a). Then, function module 225a would output a table of reference names and descriptions between the objects (or tables) of the inputted package. Further, after the desired metadata is extracted, the software application 200 graphically depicts the extracted metadata on a display.

FIG. 2B depicts an embodiment of a registration table utilized to incorporate extractors for the framework. In an embodiment, registration table 230 includes a header row for the extractors (e.g., OBJ_CATEGORY 231) and the corresponding function modules: API_PACKAGE 232 (e.g., in order to extract metadata related to any sub-packages), API_OBJECT 233 (e.g., in order to extract metadata related to the objects of the given package or sub-package), API_FIELD 234 (e.g., in order to extract metadata related to the fields of the given object)and API_REFERENCE 235 (e.g., in order to extract metadata related to any relations between the objects of the given package). In other words, the header row (e.g., 231-235) in FIG. 2B corresponds to the metadata components (e.g., 221-225) of the computing platform 220 in FIG. 2A. Similarly, extractor DDicTables 231a and corresponding function modules 232a-235a are equivalent to extractor 221a and corresponding function modules 222a-225a of the computing platform 220 in FIG. 2A. Likewise, extractor BWExt 231b and corresponding function modules 232b-234b are equivalent to extractor 221b and corresponding function modules 222b-224b of the computing platform 220 in FIG. 2A. In an embodiment, each of the names of the function modules (e.g., 232a-235a and 222b-224b) in the registration table 230 are wrappers for existing functionality in the computing platform, which will be further described with regard to FIG. 2C.

In an embodiment, a developer may include additional extractors to the framework by registering the extractor and the corresponding function modules with the registration table. Accordingly, the additional extractor and corresponding function modules would appear in the row below the row including the extractor 221b and corresponding function modules 222b-224b. In an embodiment, by adding new rows to the registration table, the framework automatically inherits additional functionality corresponding to the added extractor. Further, in an embodiment, once the software application (e.g., software application 200 of FIG. 2A) connects (or reconnects) to the computing platform (e.g., computing platform 220 of FIG. 2A), the software application automatically consumes the registration table 230 to determine the types of extractors and corresponding function modules made available to the software application.

FIG. 2C illustrates an embodiment of source code utilized to implement a function module at the computing platform. In an embodiment, source code 240 of FIG. 2C is implemented in the computing platform when function module 223a of FIG. 2A (or 233a of FIG. 2B) is called. Further, in an embodiment, function module 223a of FIG. 2A (or 233a of FIG. 2B) corresponds to a function Z_DDIC_GET_TABLE_TAB stored in the computing platform. In an embodiment, Z_DDIC_GET_TABLE_TAB takes in I_PACKAGE_NAME (e.g., name of package or sub-package) and outputs a Table, E_TAB_OBJECT which contains OBJECT_NAME (e.g., name of the object of the given package or sub-package) and OBJECT_DESCRIPTION (e.g., description of the object of the given package or sub-package). Specifically, to extract the name and the description of all objects contained in a given package, the function has to select all the fields of the column obj_name in the table tadir where the given package name I_PACKAGE NAME is listed in the field devclass and the field object contains the string ‘TABL’. Further, to ensure that the selected object is indeed a database table, the field tabclass in dd02l has to be ‘TRANSP’ (e.g., which is why the tables tadir and dd02l are joined). Further, the descriptions are contained in dd02t. Therefore, an additional join between tadir and dd02t is done to select ddtext as the description.

In an embodiment, the other function modules (e.g., 222a, 224a and 225a of FIG. 2A or 232a, 234a and 235a of FIG. 2B) also have corresponding functions stored in the computing platform utilizing similar source code. Similarly, functions modules corresponding to extractor BWExt (e.g., 221b of FIG. 2A or 231b of FIG. 2B) and any other additional extractors, for that matter, would also have corresponding functions stored in the computing platform utilizing similar source code.

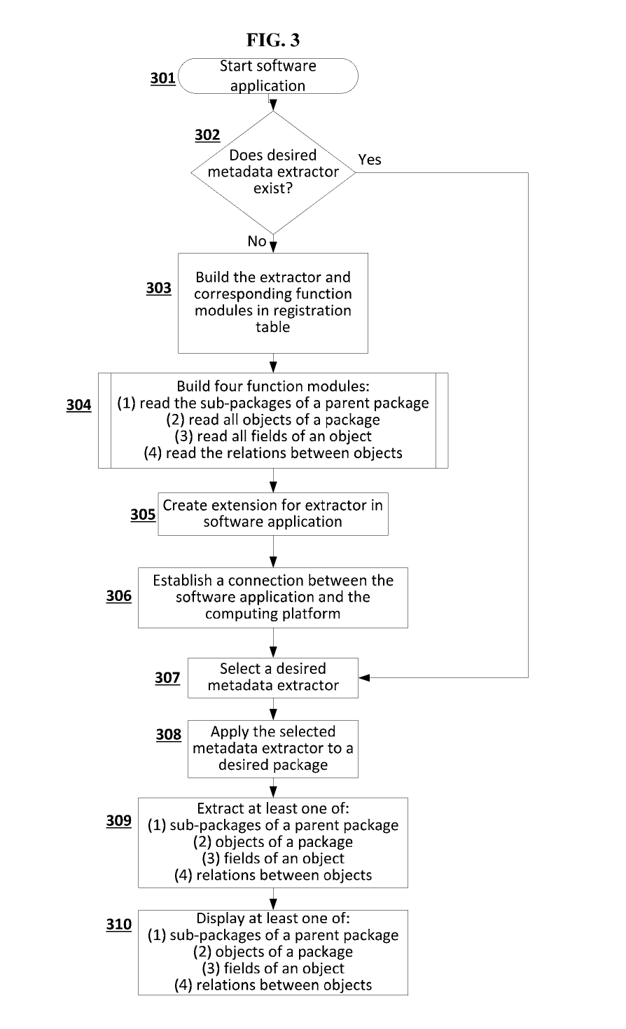

FIG. 3 illustrates an embodiment of a method utilizing the framework of the present invention. In step 301, the software application is initialized. In step 302, it is determined if a desired metadata extractor exists in the software application. If so, then the method proceeds to step 307. Otherwise, the method proceeds to step 303. In step 303, the user builds the extractor and corresponding function modules in the registration table. Specifically, in step 304, the user builds four function modules which: (1) read the sub-packages of a parent package, (2) read all objects of a package, (3) read all fields of an object, and (4) read the relations between objects. After which, in step 305, the user creates an extension for the built extractor in the software application. Then, in step 306, the user establishes a connection between the software application and the computing platform including the stored metadata. In an embodiment, the connection between the software application and the computing platform can be established utilizing connection software (e.g., SAP Connection®) that provides the software application access to specific systems in the computing platform. Once the connection is established, in step 307, the user selects a desired metadata extractor to utilize. Then, in step, 308, the user applies at least one of the function modules corresponding to the selected extractor to a desired package. Accordingly, in step 309, at least one of: (1) sub-packages of a parent package, (2) objects of a package, (3) fields of an object and (4) relations between objects is extracted from a metadata storage location at the computing platform. Once extracted, in step 310, the metadata related to at least one of: (1) sub-packages of a parent package, (2) objects of a package, (3) fields of an object and (4) relations between objects is utilized (e.g., modeled) by the software application and displayed on a display.

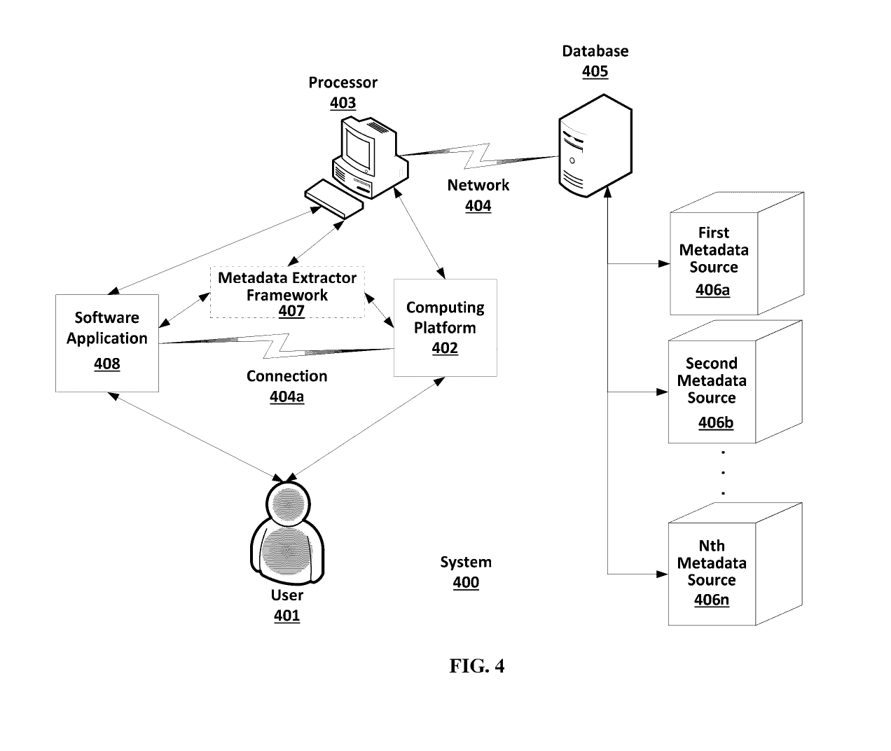

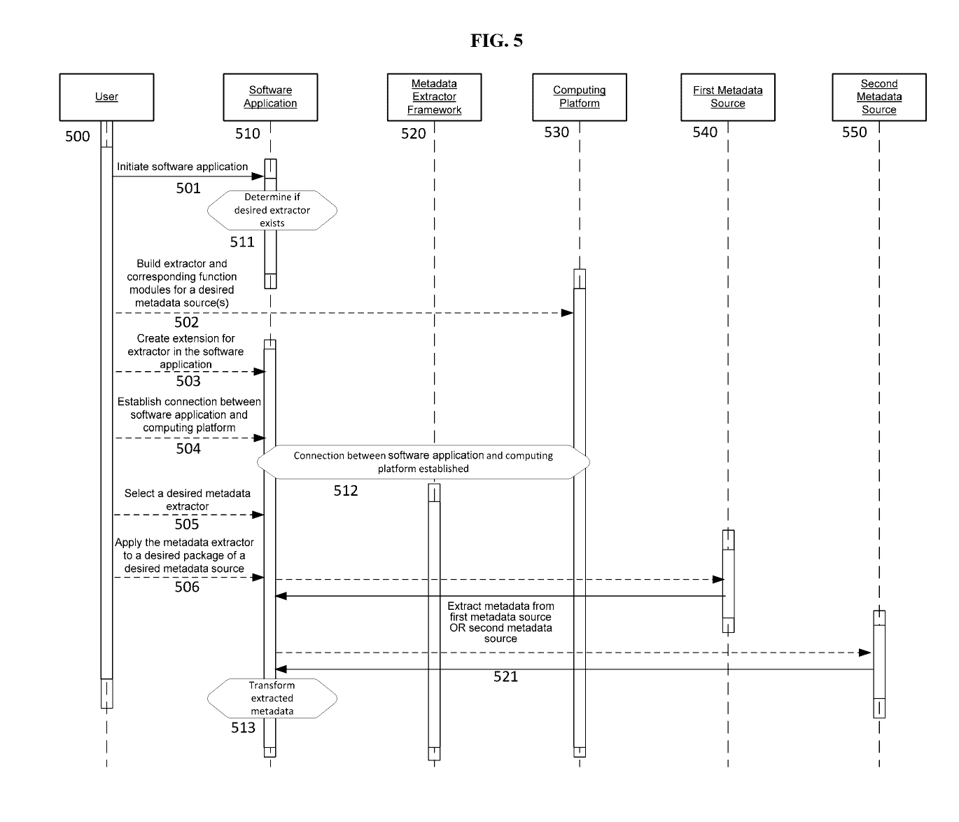

FIG. 4 illustrates an embodiment of a system utilizing the framework of the present invention. In an embodiment, system 400 includes a software application 408, computing platform 404, metadata extractor framework 407, framework connection 404a, network 404, processor 403 (with a display), and database 405 including a first metadata source 406a, second metadata source 406b to an nth metadata source 406n. In an embodiment, computing platform 402 can refer to any type of computing platform, e.g., SAP NetWeaver® platform. Further, in an embodiment, software application 408 can refer to any type of graphical user interface software application, e.g., SAP Power Designer® EnterpriseArchitect. Further, in another embodiment, software application 408 can run on a different processor than the processor the computing platform 402 is run on (e.g., processor 403). Further, in an embodiment, the connection 404a is established between the software application 408 and the computing platform 402 with any type of connection software, e.g., SAP Connection®. In an embodiment, the connection 404a can be over any communication network. Further, in an embodiment, metadata extractor framework 407 is implemented partially in the software application 408 and partially in the computing platform 402. Further, in an embodiment, each of the n metadata sources refer to different storage locations (e.g., DDIC, BW DataSource, etc.) at the computing platform (e.g., SAP NetWeaver® platform). Further, in an embodiment, the database 405 is an in-memory database. In another embodiment, the database 405 is supported by the SAP Netweaver® platform.

FIG. 5 illustrates an embodiment of the interaction between the elements of the system. In step 501, the user 500 initiates the software application 510. In step 511, it is determined if the desired metadata extractor exists at the software application 510. In step 502, the user 500 builds, with the computing platform 530, an extractor, with corresponding function modules, for a desired metadata source (e.g., first metadata source 540 or second metadata source 550). In step 503, the user 500 creates an extension for the built extractor in the software application 510. In step 504, the user 500 establishes a connection between the software application 510 and the computing platform 530. Accordingly, in step 512, a connection between the software application 510 and the computing platform 530 is established. In step 505, the user 500 selects a desired metadata extractor to utilize. Further, in step 506, the user 500 applies the selected metadata extractor to a desired package of a desired metadata source (e.g., first metadata source 540 or second metadata source 550). Accordingly, depending on which metadata extractor was selected, in step 532, metadata is extracted from either the first metadata source 540 or the second metadata source 550). Finally, in step 513, the software application 510 transforms (e.g., models) the extracted metadata and displays the transformation (e.g., model) of the extracted metadata on a display to the user 500.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

Although the foregoing invention has been described in some detail for purposes of clarity of understanding, it will be apparent that certain changes and modifications can be practiced within the scope of the appended claims. The described embodiment features can be used with and without each other to provide additional embodiments of the present invention. The present invention can be practiced according to the claims without some or all of these specific details. For the purpose of clarity, technical material that is known in the technical fields related to the invention has not been described in detail so that the present invention is not unnecessarily obscured. It should be noted that there are many alternative ways of implementing both the process and apparatus of the present invention. Accordingly, the present embodiments are to be considered as illustrative and not restrictive, and the invention is not to be limited to the details given herein, but can be modified within the scope and equivalents of the appended claims.

What is claimed is:

1. A computer-implemented method for extracting metadata from a plurality of metadata storage locations at a computing platform:
establishing, with a processor, a connection between a graphical user interface software application and the computing platform;
consuming, at the graphical user interface software application, with the processor, a registration table, wherein the registration table includes a plurality of metadata extractors and corresponding function modules;
upon determining, by the processor, a user selection of one of the plurality of metadata extractors, applying the user-selected extractor on metadata from one of the plurality of metadata storage locations at the computing platform; and
extracting, with the user-selected extractor, to the graphical user interface software application, the metadata from one of the plurality of metadata storage locations at the computing platform.

2. The method of claim 1, further comprising:
transforming, with the graphical user interface software application, the extracted metadata and;
displaying, with the graphical user interface software application, on a display, the transformed extracted metadata.

3. The method of claim 1, wherein: (i) one of the function modules is directed to extracting metadata related to at least one sub-package of a package at one of the plurality of metadata storage locations at the computing platform, (ii) one of the function modules is directed to extracting metadata related to at least one object of the package or the at least one sub-package, (iii) one of the function modules is directed to extracting metadata of at least one field of the at least one object and (iv) one of the function modules is directed to extracting metadata related to at least one relation between at least two objects of the package or the at least one sub-package.

4. The method of claim 1, wherein each of the plurality of metadata extractors corresponds to a different metadata storage location of the plurality of metadata storage locations at the computing platform.

5. The method of claim 2, wherein the transformed extracted metadata includes a hierarchical structure, wherein the hierarchical structure includes at least one of (i) a package component (ii) at least one sub-package component of the package component, (iii) at least one object component of the package component or the at least one sub-package component, (iv) at least one field component of the at least one object component and (v) at least one relation connection between at least two objects of the package or the at least one sub-package.

6. The method of claim 5, wherein a color of a connection between at least one of (i) the package component and the at least one sub-package component, (ii) the at least one object component and the package component or the at least one sub-package component and (iii) the at least one field and the at least object, is distinct from a color of the relation connection.

7. The method of claim 2, wherein the transforming step includes modeling the extracted metadata at the graphical user interface software application.

8. A non-transitory computer readable medium containing program instructions for extracting metadata from a plurality of metadata storage locations at a computing platform, wherein execution of the program instructions by one or more processors of a computer system causes one or more processors to carry out the steps of:
establishing a connection between a graphical user interface software application and the computing platform;
consuming, at the graphical user interface software application, a registration table, wherein the registration table includes a plurality of metadata extractors and corresponding function modules;
upon determining a user selection of one of the plurality of metadata extractors, applying the user-selected extractor on metadata from one of the plurality of metadata storage locations at the computing platform; and
extracting, with the user-selected extractor, to the graphical user interface software application, the metadata from one of the plurality of metadata storage locations at the computing platform.

9. The non-transitory computer readable medium of claim 8, further comprising:
transforming, with the graphical user interface software application, the extracted metadata and;
displaying, with the graphical user interface software application, on a display, the transformed extracted metadata.

10. The non-transitory computer readable medium of claim 8, wherein: (i) one of the function modules is directed to extracting metadata related to at least one sub-package of a package at one of the plurality of metadata storage locations at the computing platform, (ii) one of the function modules is directed to extracting metadata related to at least one object of the package or the at least one sub-package, (iii) one of the function modules is directed to extracting metadata of at least one field of the at least one object and (iv) one of the function modules is directed to extracting metadata related to at least one relation between at least two objects of the package or the at least one sub-package.

11. The non-transitory computer readable medium of claim 8, wherein each of the plurality of metadata extractors corresponds to a different metadata storage location of the plurality of metadata storage locations at the computing platform.

12. The non-transitory computer readable medium of claim 9, wherein the transformed extracted metadata includes a hierarchical structure, wherein the hierarchical structure includes at least one of (i) a package component (ii) at least one sub-package component of the package component, (iii) at least one object component of the package component or the at least one sub-package component, (iv) at least one field component of the at least one object component and (v) at least one relation connection between at least two objects of the package or the at least one sub-package.

13. The non-transitory computer readable medium of claim 12, wherein a color of a connection between at least one of (i) the package component and the at least one sub-package component, (ii) the at least one object component and the package component or the at least one sub-package component and (iii) the at least one field and the at least object, is distinct from a color of the relation connection.

14. The non-transitory computer readable medium of claim 9, wherein the transforming step includes modeling the extracted metadata at the graphical user interface software application.

15. A system directed to extracting metadata from a plurality of metadata storage locations at a computing platform, comprising of:
a database, wherein the database includes the plurality of metadata storage locations;
a processor, wherein the processor is configured to perform the steps of:
establishing a connection between a graphical user interface software application and the computing platform;
consuming, at the graphical user interface software application, a registration table, wherein the registration table includes a plurality of metadata extractors and corresponding function modules;
upon determining a user selection of one of the plurality of metadata extractors, applying the user-selected extractor on metadata from one of the plurality of metadata storage locations at the computing platform; and
extracting, with the user-selected extractor, to the graphical user interface software application, the metadata from one of the plurality of metadata storage locations at the computing platform.

16. The system of claim 15, further comprising:
a display;
wherein the processor is configured to further perform the steps of:
transforming, with the graphical user interface software application, the extracted metadata and;
displaying, with the graphical user interface software application, on the display, the transformed extracted metadata.

17. The system of claim 15, wherein: (i) one of the function modules is directed to extracting metadata related to at least one sub-package of a package at one of the plurality of metadata storage locations at the computing platform, (ii) one of the function modules is directed to extracting metadata related to at least one object of the package or the at least one sub-package, (iii) one of the function modules is directed to extracting metadata of at least one field of the at least one object and (iv) one of the function modules is directed to extracting metadata related to at least one relation between at least two objects of the package or the at least one sub-package.

18. The system of claim 15, wherein each of the plurality of metadata extractors corresponds to a different metadata storage location of the plurality of metadata storage locations at the computing platform.

19. The system of claim 16, wherein the transformed extracted metadata includes a hierarchical structure, wherein the hierarchical structure includes at least one of (i) a package component (ii) at least one sub-package component of the package component, (iii) at least one object component of the package component or the at least one sub-package component, (iv) at least one field component of the at least one object component and (v) at least one relation connection between at least two objects of the package or the at least one sub-package.

20. The system of claim 16, wherein the transforming step includes modeling the extracted metadata at the graphical user interface software application.
